(19) United States
(12) Patent Application Publication
(10) Pub. No.: US 2017/0241620 A1
(43) Pub. Date: Aug. 24, 2017

(54) ATTACHMENT FOR OUTLETS, LIGHT SWITCHES, AND OTHER FIXTURES TO AID LOCATING AND USE

(71) Applicant: Urban Outlights LLC, Woodmere, NY (US)

(72) Inventor: Benjamin Jacob AIVAZI, Woodmere, NY (US)

(73) Assignee: Urban Outlights LLC, Woodmere, NY (US)

(21) Appl. No.: 15/439,466

(22) Filed: Feb. 22, 2017

Related U.S. Application Data
(60) Provisional application No. 62/298,938, filed on Feb. 23, 2016.

(51) Int. Cl. F21V 9/16; H01R 25/00; H01R 13/52; F21V 23/04; H01H 9/02

(52) U.S. Cl. CPC F21V 9/16; F21V 23/04; H01H 9/02; H01R 13/5213; H01R 25/006

(57) ABSTRACT

The attachment generally takes on the form of a removable decal that one places over the fixture, such as an outlet. The attachment may glow in the dark, by use of common glow-in-the-dark materials such as glow-in-the-dark paint or phosphorescent paper. This enables the fixture to be easily located in the dark for turning on a light switch or plugging in a plug into an outlet. The attachment can also be illuminated through electrical means, such as by using electroluminescent paper. In other embodiments, the attachment is not illuminated and contain a design to make the fixture more noticeable, aesthetically pleasing, and easier to access.

### FIELD OF THE INVENTION

The present invention provides an attachment for outlets, light switches, or other fixtures to make the fixtures more noticeable, aesthetically pleasing, and easier to access, either in lit environments, unlit environments, or both.

### BACKGROUND

Outlet or light fixture covers with designs are generally known in the art. However, changing or replacement of these fixture covers often requires unscrewing a faceplate and attaching a new faceplate, requiring the usage of tools, such as a screwdriver. Also, because the design is generally across the entirety of the faceplate, a user cannot change just a portion of the design. And, if the design is not to a user's liking, such as a new homeowner, the entire fixture must be replaced. Therefore, a need exists for a fixture on which the design can easily be changed without permanently altering the fixture or faceplate.

### SUMMARY

The attachment generally takes on the form of a removable decal that one places over the fixture, such as an outlet. The attachment may glow in the dark, by use of common glow-in-the-dark materials such as glow-in-the-dark paint or phosphorescent paper. This enables the fixture to be easily located in the dark for turning on a light switch or plugging in a plug into an outlet. The attachment can also be illuminated through electrical means, such as by using electroluminescent paper. In other embodiments, the attachment is not illuminated and has a design to make the fixture more noticeable, aesthetically pleasing, and easier to access.

### BRIEF DESCRIPTION OF THE DRAWINGS

FIGS. 1-6 depict various view of light switch fixtures having attachments in accordance with the present invention.

FIG. 7-17 depict various views of outlets having attachments in accordance with the present invention.

FIG. 18 depicts an alternate embodiment of the attachment in which accessories may be used to enhance a primary attachment.

### DETAILED DESCRIPTION

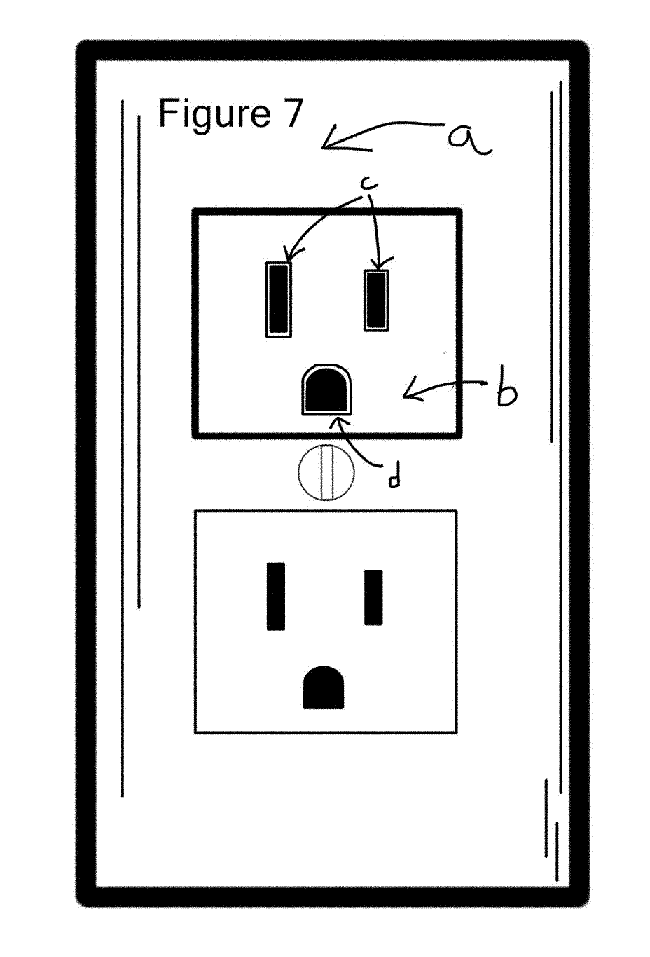

The attachments of the present invention can be made of many kinds of materials. In the preferred embodiment, they are made on sticker paper, which can then be stuck onto the fixture being used. However, they can also be made of a piece of plastic or other material. For the attachment to an outlet (or for other fixtures, when necessary), the attachment should be thin enough so as to still allow for use of the fixture. For example, in an embodiment where the invention is an attachment for an outlet as depicted in FIG. 7-17, the attachment should be thin enough so that one can plug something into the outlet effectively.

The attachments can be attached through various methods. In the preferred embodiment, they are attached to the fixture by a sticker or adhesive located on the back of the attachment, although they can also be attached using static, magnetic, or mechanical connectors located in such a location so as to facilitate the affixing of the attachment to the fixture, without inhibiting access to the use of the fixture.

The attachments serve multiple purposes, which most notably include, but are not limited to, the following:

They facilitate access to the fixtures in question during lit environments, and/or, in the preferred embodiment (one that glows in the dark), in dark environments as well.

When the attachment is attached to a wall fixture in the dark, such as an outlet or a light switch, the invention prevents scratches or dirtying of the wall or other household items located near the fixture. Situations where one attempts to locate the fixture in the dark often result in unintentionally scratching or dirtying walls or other nearby household furnishings with, for example, the charger prongs or one's hand.

Since the attachments, in some embodiments, are visible in the dark, one can locate and use the fixture in question in the dark with precision, thus eliminating the frustration and time spent fumbling around for the fixture.

Additionally, even in lit environments, the attachment, in some embodiments (which may or may not glow in the dark), provides an element of design that highlights often unnoticed interior details, providing insight into the precise location of the fixtures, as well as providing an improvement in the aesthetic quality of the surrounding area.

Those embodiments that are illuminated in the dark, whether through glow-in-the-dark or through electric means, can also function as a night-light as well.

The invention can serve to change the apparent color schemes, appearance, form, or design of existing outlets, light switches, or other fixtures in a simple, non-permanent way that allows for full functionality of the existing fixture in question.

The invention is an inexpensive, durable, lightweight and cost-effective, as well as an easy to use and low maintenance, way of fulfilling the above objectives.

Unlike existing solutions for outlet, light switch, or other fixture illuminations, the attachments are easy to attach and remove, and does not require tools or the replacing of the existing faceplate/fixture cover. The attachments can simply be set on top of whatever fixture or fixture cover is already in place. The embodiment that glows in the dark is unique as well because it only glows visibly in the dark, and does not provide an unnecessarily lit distraction during the day, and does not require electricity to run as the attachment is illuminated by glow-in-the-dark material. This material is long lasting, and does not require maintenance for proper performance. All of the embodiments would be made of material that is safe and durable.

### ELECTRICAL OUTLET ATTACHMENTS

For the embodiments depicted in FIG. 7-17, for electrical outlets, the attachment is a cover to the outlet fixture that can be made as a sticker or decal, or as a piece of plastic or other material thin enough that it does not interfere with plugging something into the outlet. The attachment is also of a size so that it does not prevent access to any nearby outlets.

Holes are provided in the attachment, such that the holes are the same size, shape, and spacing, or of similar size, shape, and spacing, to the outlet holes for the prongs. These holes are made to align with the existing holes on an outlet (namely, the rectangular, “slot”-like holes, and, where applicable, the third “ground” hole), such that when the attachment is placed over the outlet, it covers only the area surrounding the outlet holes, but not the holes themselves. This allows for the outlet to be used with the attachment attached, whereby the prongs of an electrical plug are inserted into the attachment and, subsequently, the outlet itself.

In embodiments where the attachment glows in the dark, the glowing area may surround at least the two rectangular prong holes, and, in some embodiments, the third hole as well. In the dark, the outlet attachment would illuminate the outlet holes by glowing, which would guide the user to place the plug of their device precisely into the outlet, and not have to try to get it in the dark, where it can be quite difficult. The holes can be made slightly larger than the holes of the outlet, so as to give more leeway with how precisely the attachment must be applied. However, the holes in the attachment should be small enough so as to illuminate the outlet well enough to allow for precise plugging in.

In the preferred embodiment, the invention is printed as one would print a sticker or decal, and is cut to the shape of the design being used. Parts of the decal may be printed in color, but the area surrounding the two rectangular holes, and sometimes the third hole, will be able to glow in the dark. Pictures are attached below. Being that it is a sticker, the attachment can be applied as one would apply an ordinary sticker, and the adhesive backing would keep it attached to the outlet.

The attachment is added to a fixture by simply placing it over the outlet that one wishes to illuminate. In short, the attachment is a sticker that one can put over an outlet, with the unique aspect that it glows in the dark, and makes it easy to access in the dark, in addition to fulfilling most, if not all, of the other objectives that are mentioned above.

When the attachment is in the form of a thin piece of plastic or other material, the attachment can be printed or made using a molding, among other methods of production. It takes on a similar shape to the sticker embodiment, with holes cut out to facilitate access to the outlet. The attachments can also be attached using an adhesive, static, magnetic, or mechanical connectors, among other methods.

In embodiments that do not glow in the dark, the attachments takes the same form as the sticker or the thin plastic attachment, but do not require any part to glow in the dark. It is, however, made with a design that is eye catching and makes the outlet easier to locate.

The stickers can be plain or with a design on them. They can also be made into a variety of shapes. In certain embodiments, a design is made whereby the holes of the outlet contribute to the image in some way. For example, the two rectangular holes form the eyes of an image or the keys on a piano, while the third hole can form a mouth or nose, among other designs.

### LIGHT SWITCH FIXTURE ATTACHMENTS

The attachments for light switch fixture attachments can be made of the same materials as the outlet attachment, and using the same methods as the outlet attachment. Like the outlet attachment, they can also take on various designs, and are attached in a similar way. They are made so that they either surround the light switch, or they can be placed on top of the light switch, without hindering access to the switch or interfering with the operation of the switch.

### ALTERNATE FIXTURE ATTACHMENTS

The attachments are made similar to the attachments described above, and are constructed in such a way so as to not obscure or hinder the access or use of the fixture in any way.

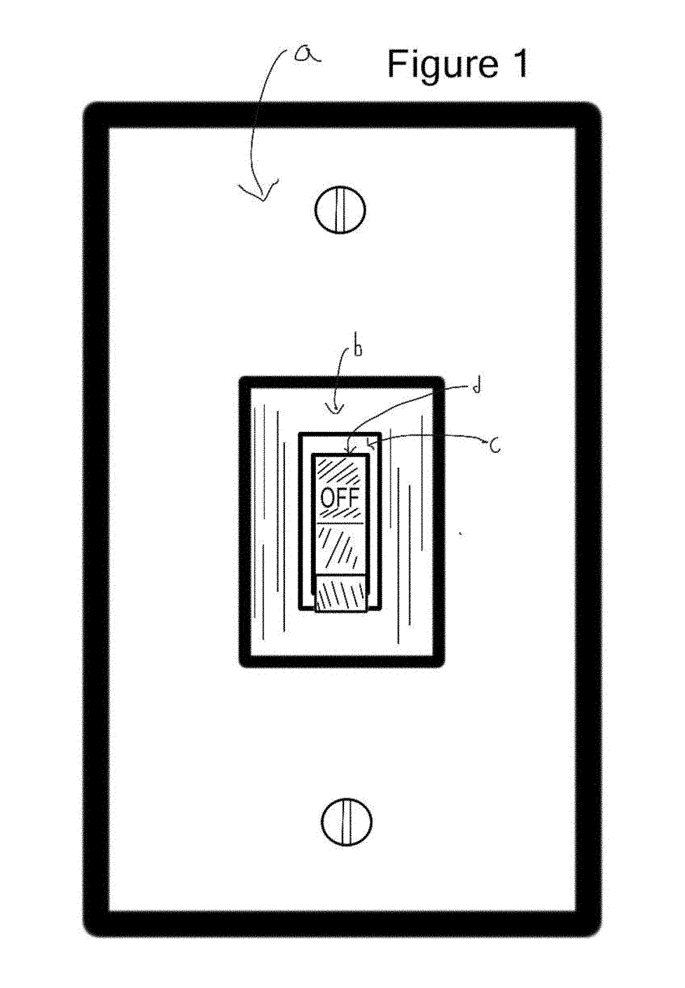

Various features and embodiments of the attachments will now be described with reference to the drawings. FIG. 1 is an example of a light switch faceplate having an attachment. In the drawings, element (a) is the faceplate and element (b) is the attachment placed thereon. The attachment (b) (either a sticker or other kind of attachment as is described above) is placed over the switch. In this embodiment, the attachment (b) glows in the dark. The attachment (b) has hole (c) so that the attachment (b) does not obstruct the switch or limit its functionality in any way. The hole (c) can be made larger (for more leeway for how precisely it is to be attached) or smaller (for a glowing effect that more precisely shows where the switch is). The light switch (d) remains uncovered so as not to hinder use.

Alternatively, the hole in the attachment (b) can be made so precise so as to fit exactly over the light switch (d), such that element (c) is part of element (b), and element (d) points to the hole (c) that is in the attachment (b).

In alternative embodiments, the attachment may not be glow in the dark, but may be of a color or pattern that makes it attractive and aesthetically pleasing.

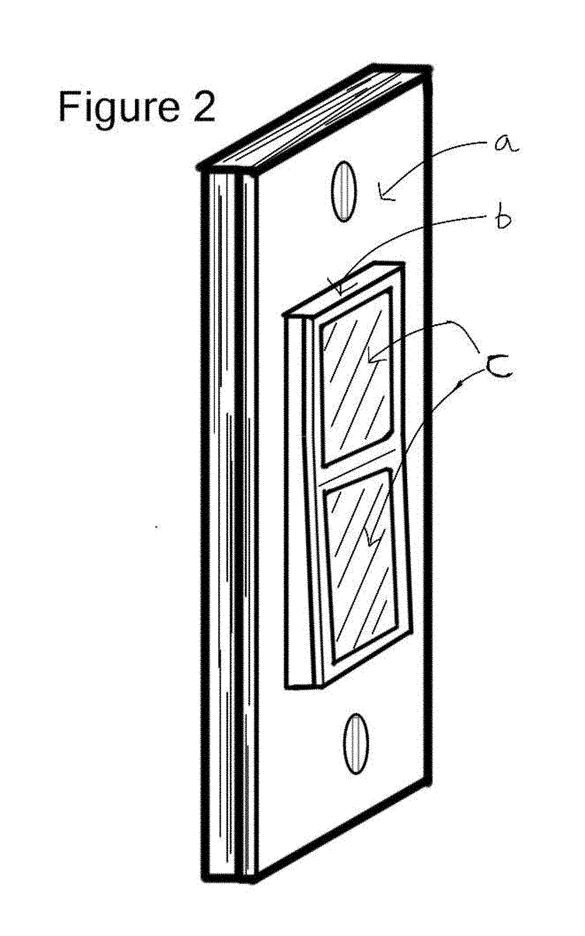

FIG. 2 depicts a perspective view of a light switch attachment on a different type of light switch different from FIG. 1. Element (a) is the existing faceplate of this switch. Element (b) is the switch itself. Element (c) is the attachment, in the form of a glow in the dark attachment that is attached to the switch itself (and not around it, as in FIG. 1). Specifically, the lined parts that the arrows point to glow in the dark. The attachment (c) is one piece that goes over most, or all, of the switch. Alternatively, the attachment (c) may not be glow in the dark, but may be of a color or pattern that makes it attractive and aesthetically pleasing.

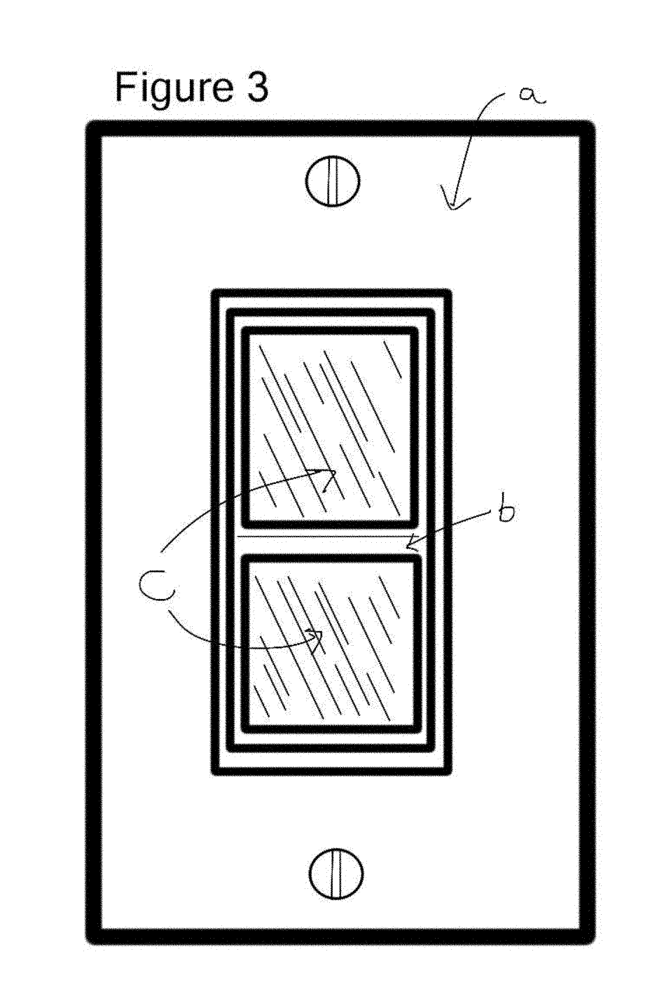

FIG. 3 depicts a front view of the light switch of FIG. 2. Element (a) is the existing faceplate of the light switch. Element (b) is the switch itself. Element (c) is the attachment, in the form of two glow in the dark attachments to the switch itself (and not around it, as in FIG. 1). Specifically, the lined parts that the arrows refer to glow in the dark. This attachment (c) is in the form of two pieces, one of which is put on each half of the light switch. Alternatively, the attachment (c) may not be glow in the dark, but may be of a color or pattern that makes it attractive and aesthetically pleasing.

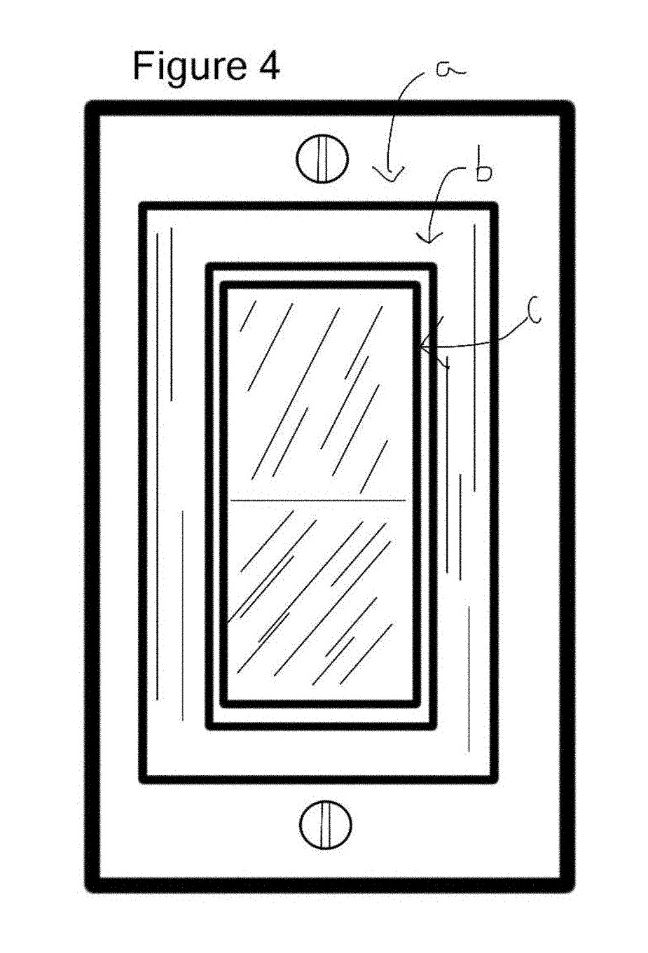

FIG. 4 depicts an attachment that goes around the light switch and not on top. Element (a) is the existing faceplate of the light switch. Element (b) is the attachment, in the form of a glow in the dark attachment to the switch (which goes around the switch, and not on top of it). A hole is made to accommodate going over the existing switch without obstructing it or limiting its functionality in any way. Alternatively, the attachment may not be glow in the dark, but may be of a color or pattern that makes it attractive and aesthetically pleasing. Element (c) is the switch itself, which does not have any attachments.

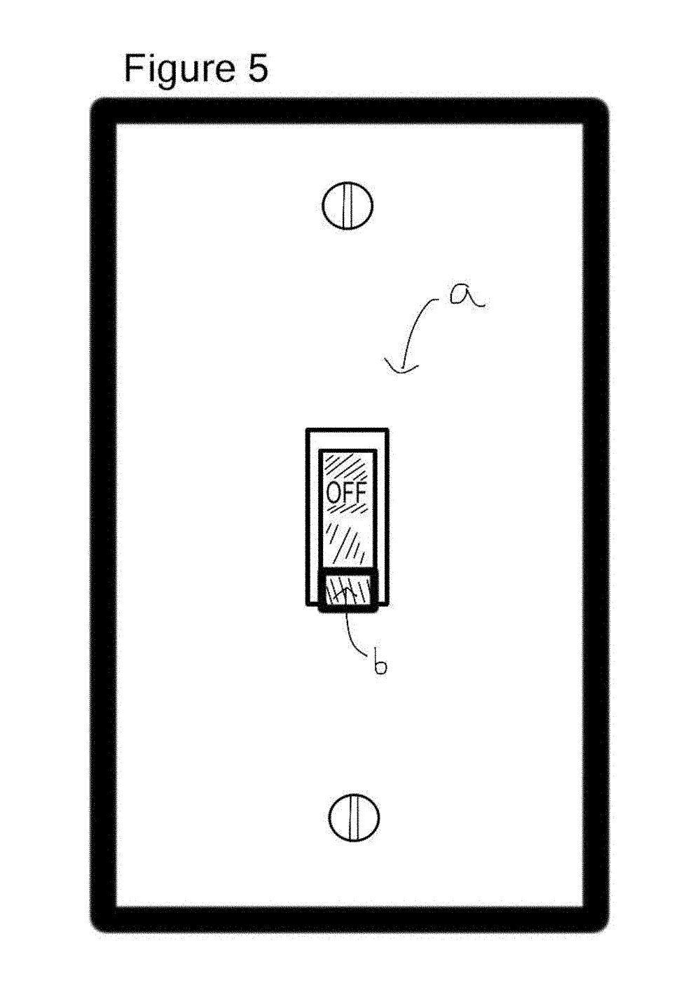

FIG. 5 is the light switch of FIG. 1 having the attachment on the switch itself instead of around it. Element (a) corresponds to the existing faceplate of the switch. Element (b) is the attachment, which goes on the tip of the switch itself. In the preferred embodiment, the attachment (b) glows in the dark. In alternative embodiments, the attachment may not glow in the dark, but may be of a color or pattern that makes it attractive and aesthetically pleasing.

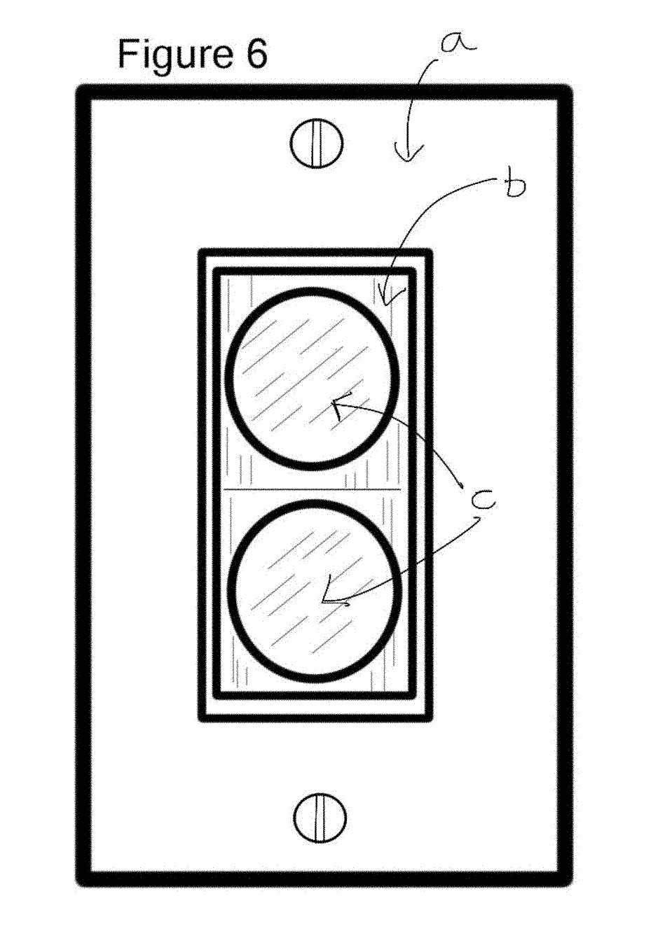

FIG. 6 depicts the light switch from FIGS. 2,3,4, with the attachment in the form of two pieces that get attached to the switch. These attachments are smaller than those depicted in FIG. 3. Element (a) corresponds to the existing faceplate of the switch. Element (b) corresponds to the switch itself. Element (c) corresponds to the attachment, which is in the form of two separate glow in the dark pieces that can be applied either individually or together. In alternative embodiments, the attachment (c) may not be glow in the dark, but may be of a color or pattern that makes it attractive and aesthetically pleasing.

FIG. 7 depicts a first embodiment of an attachment for outlets. In the preferred embodiment, the attachment glows in the dark. In alternative embodiments, the attachment may not be glow in the dark, but may be of a color or pattern that makes it attractive and aesthetically pleasing. In other alternative embodiments, the attachment is lit by electric means.

Element (a) corresponds to the existing faceplate of the outlet. Element (b) corresponds to the attachment itself, which is in the embodiment of an attachment for outlets. The attachment can be a sticker or other form of attachment, as already described. Element (c) are two holes that are made in the attachment (b) to not obstruct access to the outlet holes. The holes are of the proper size, shape and spacing to allow for easy plugging into the outlet. The holes (c) correspond to and align with the holes on the outlet. Element (d) corresponds to the third hole in the attachment, which is made of the same size, shape, and spacing to accommodate plugging into the third hole (typically ground) unobstructed. The holes of (c) and (d) are of the proper size, shape and spacing to allow for easy plugging into the holes. They correspond to and align with the holes on the outlet. Their presence ensures that the outlet is not obstructed, and that the outlet retains full functionality.

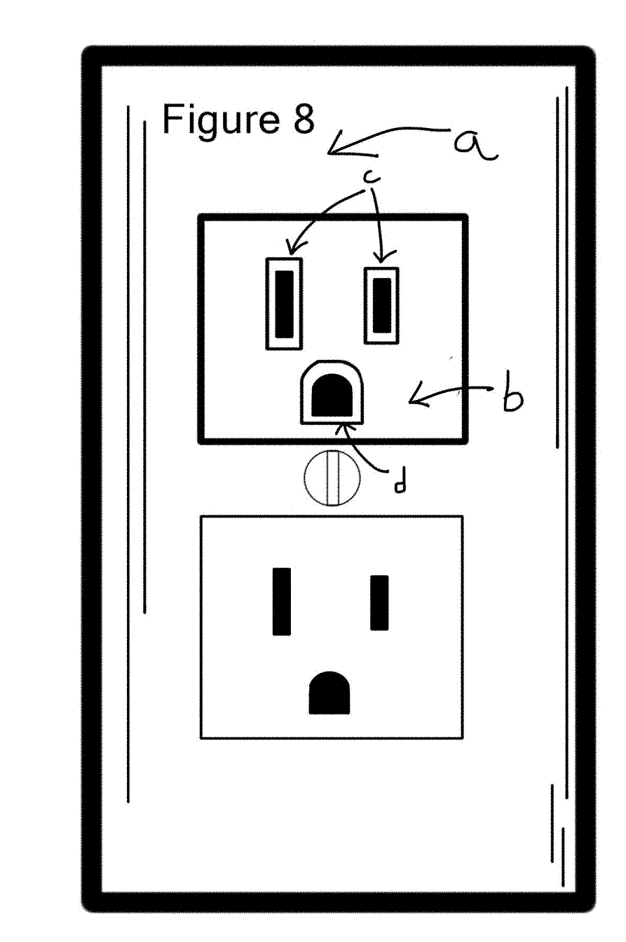

FIG. 8 corresponds to the outlet and attachment of FIG. 7, but with the holes in the attachment made larger to allow for easier placement of the attachment. Element (a) corresponds to the existing faceplate of the outlet. Element (b) corresponds to the attachment itself, which is in the embodiment of an attachment for outlets. The attachment (b) can be a sticker or other form of attachment, as previously described. Element (c) corresponds to the two holes that are made in the attachment (b) to not obstruct access to the outlet holes. The holes (c) are of the proper size, shape and spacing to allow for easy plugging into the holes of the outlet, while being larger than the holes in FIG. 7 to allow for more leeway when attaching the attachment (b) to faceplate (a). Element (d) corresponds to the third hole in the attachment (b), which is made the same size, shape, and spacing to accommodate plugging into the third hole of the outlet in an unobstructed fashion.

In the preferred embodiment, the attachment (b) of FIG. 8 glows in the dark. In alternative embodiments, the attachment (b) may not be glow in the dark, but may be of a color or pattern that makes it attractive and aesthetically pleasing. In other alternative embodiments, the attachment (b) is lit by electric means. The holes (c) and (d) in the attachment (b) are of the proper size, shape and spacing to allow for easy plugging into the holes. They correspond to and align with the holes on the outlet. Their presence ensures that the outlet is not obstructed, and that it retains full functionality.

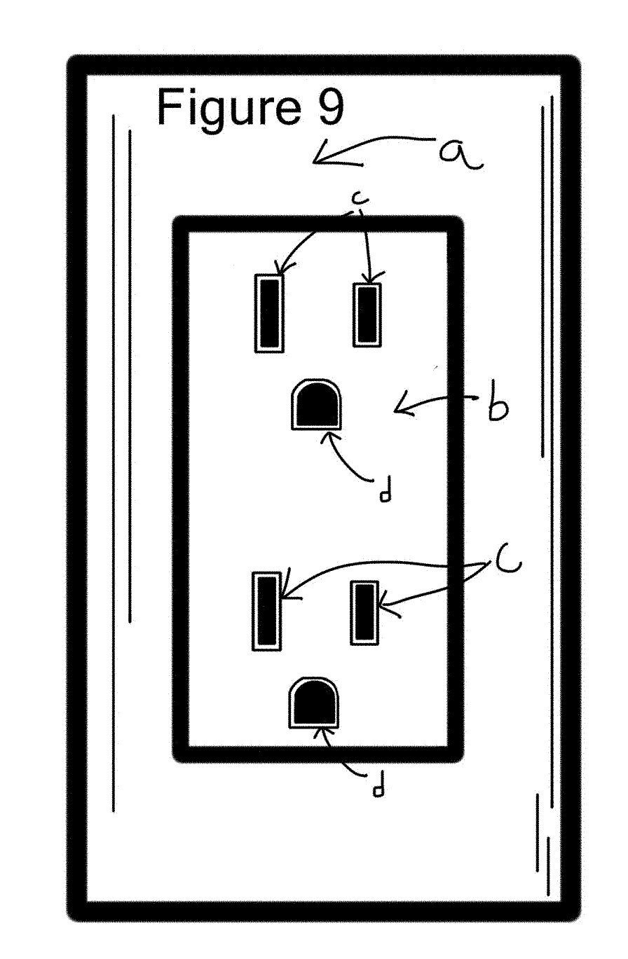

FIG. 9 corresponds to the outlet and attachment of FIGS. 7 and 8, but with the attachment made to cover two outlets. One benefit of this is to be able to illuminate two outlets with only one attachment. This limits the need for a proper application of the attachment to one time only. Element (a) corresponds to the existing faceplate of the outlet. Element (b) corresponds to the attachment, which is in the embodiment of an attachment to two outlets. The attachment (b) can be a sticker or other form of attachment, as previously described. Elements (c) corresponds to the four rectangular holes that are made in the attachment to not obstruct access to the outlet holes. The holes (c) are of the proper size, shape and spacing to allow for easy plugging into the holes. Element (d) corresponds to the third hole in the attachment for both outlets, which is made of the same size, shape, and spacing to accommodate plugging into the third hole unobstructed.

In the preferred embodiment, the attachment (b) of FIG. 9 glows in the dark. In alternative embodiments, the attachment (b) may not be glow in the dark, but may be of a color or pattern that makes it attractive and aesthetically pleasing. In other alternative embodiments, the attachment (b) is lit by electric means. The holes (c) and (d) in the attachment are the proper size, shape and spacing to allow for easy plugging into the holes. They correspond to and align with the holes on the outlet. Their presence ensures that the outlet is not obstructed, and that it retains full functionality.

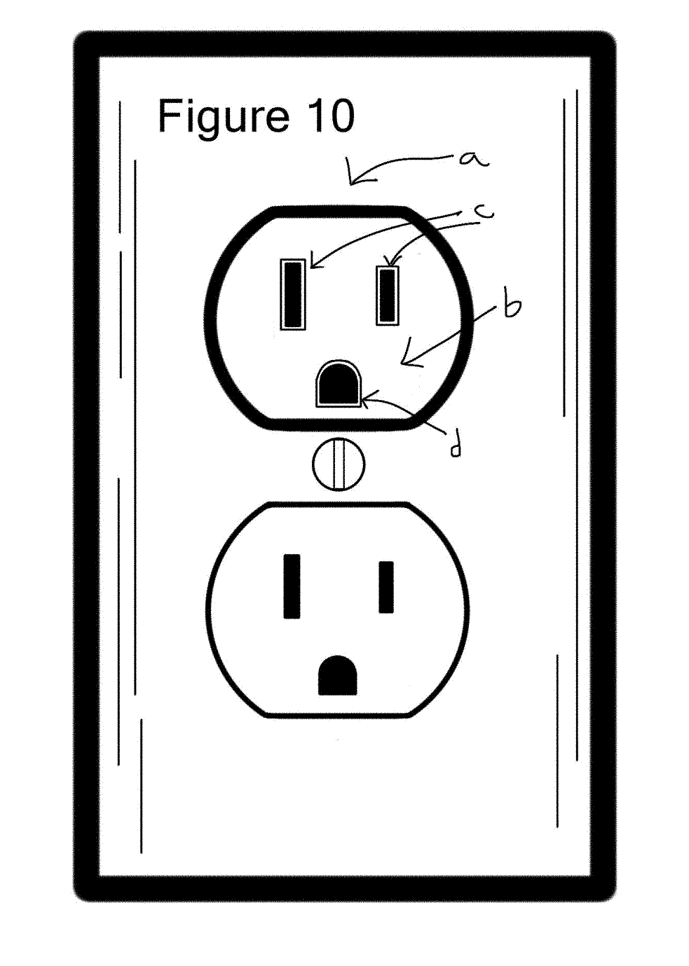

FIG. 10 corresponds to the outlet and attachment of FIGS. 7 and 8, but with the attachment made to specifically cover outlets having a circular-rectangular shape. Such outlets sometimes have the area surrounding the plug in that shape raised above the rest of the faceplate. Having an attachment of a different size might hang over the edges and make for a bad fit. Element (a) corresponds to the existing faceplate of the outlet. Element (b) corresponds to the invention itself, which is in the embodiment of an attachment to outlets. The attachment (b) can be a sticker or other form of attachment, as described in the above specification. Generally, attachment (b) has the same circular-rectangular shape as the outlet. Element (c) corresponds to the two rectangular holes that are made in the attachment to not obstruct access to the outlet holes. The holes are of the proper size, shape and spacing to allow for easy plugging into the holes. Element (d) corresponds to the third hole in the attachment, which is made of the same size, shape, and spacing to accommodate plugging into the third hole unobstructed.

In the preferred embodiment, the attachment (b) glows in the dark. In alternative embodiments, the attachment (b) may not be glow in the dark, but may be of a color or pattern that makes it attractive and aesthetically pleasing. In other alternative embodiments, the attachment (b) is lit by electric means. The holes (c) and (d) in the attachment are of the proper size, shape and spacing to allow for easy plugging into the holes. They correspond to and align with the holes on the outlet. Their presence ensures that the outlet is not obstructed, and that it retains full functionality.

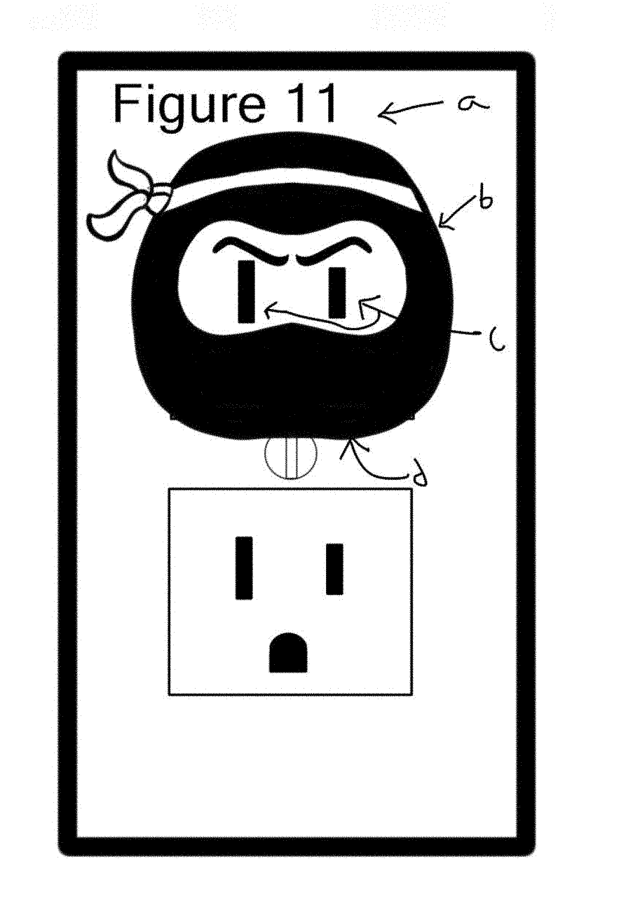

FIG. 11 depicts an embodiment of an attachment to outlets having a face design. Element (a) corresponds to the existing faceplate of the outlet. Element (b) corresponds to the attachment itself, which is in the embodiment of an attachment to outlets. The attachment (b) can be a sticker or other form of attachment, as previously described. In the preferred embodiment, the portion of attachment (b) that would glow is the white area surrounding the two rectangular holes in the attachment. In the preferred embodiment, the area surrounding the third hole does not glow. In alternative embodiments, the attachment (b) does not glow, but is attractive and noticeable, having the same design.

Element (c) correspond to the two rectangular holes that are made in the attachment (b) to not obstruct access to the outlet holes. The holes are of the proper size, shape and spacing to allow for easy plugging into the holes. In those embodiments that glow in the dark, the area glowing would be the white area surrounding element (c). In this embodiment, the two rectangular holes (c) form the “eyes” of the image depicted on the invention, adding an aesthetically pleasing feature that makes the room more aesthetically pleasing and makes the outlet more noticeable, among other functions.

Element (d) corresponds to the third hole in the attachment (b), which is made of the same size, shape, and spacing to accommodate plugging into the third hole unobstructed. In the preferred embodiment, the material surrounding the hole does not glow, and instead blends in with the color of the hole (which is a dark grey or black).

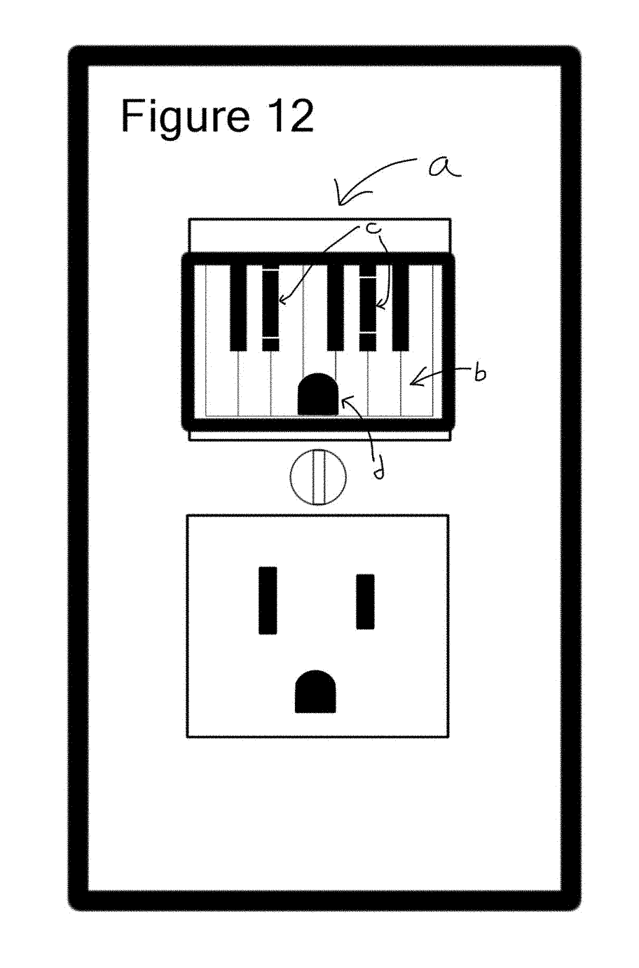

FIG. 12 depicts an attachment for an outlet, with the unique feature of the two rectangular holes in the outlet (denoted by element (c)) are part of a pattern depicting piano keys, which can be comforting to those who love music. Element (a) is the existing faceplate of the outlet. Element (b) is the attachment itself, with a design printed on it. In those embodiments that glow in the dark, the white area making up the “piano keys” glow in the dark. This attachment (b) can be either a sticker, magnetic attachment, static attachment, thin piece of plastic or other material, as described above. Element (c) are the holes in the attachment (b), corresponding in size, shape, and spacing to the holes in an outlet, made in order to allow someone to plug something into the outlet. Element (d) is the third hole in the attachment, corresponding in size and shape to the third hole on an outlet, and made in order to facilitate easier plugging into the hole.

In the preferred embodiment, the attachment (b) glows in the dark. In alternative embodiments, the attachment (b) may not be glow in the dark, but may be of a color or pattern that makes it attractive and aesthetically pleasing. In other alternative embodiments, it is lit by electric means. The holes (c) and (d) in the attachment are of the proper size, shape and spacing to allow for easy plugging into the holes. They correspond to and align with the holes on the outlet. Their presence ensures that the outlet is not obstructed, and that it retains full functionality.

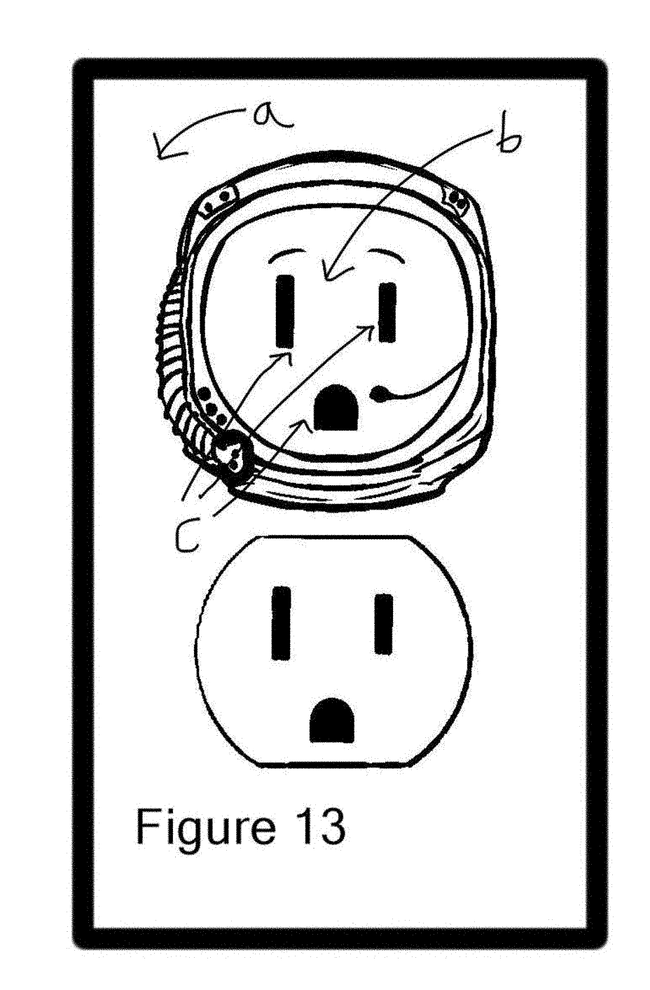

FIG. 13 depicts an attachment for an outlet. Element (a) corresponds to the existing faceplate of the outlet. Element (b) corresponds to the attachment, which is in the embodiment of an attachment to outlets. The attachment (b) can be a sticker or other form of attachment, as previously described. In this embodiment, the material that would glow (in the embodiment that glows) is the white area surrounding the two rectangular holes and the third hole in the attachment (holes denoted by (c)). Element (c) correspond to the two rectangular holes and the third “ground” hole that are made in the attachment so as to not obstruct access to the outlet holes. The holes are of the proper size, shape and spacing to allow for easy plugging into the holes, and are small enough so that they surround the holes almost fully, without obstructing them at all. In those embodiments that glow in the dark, the area glowing would be the white area surrounding elements (c) (making up the “face” of the design). In this embodiment, the two rectangular holes form the “eyes” of the image depicted on the invention, and the third hole forms the “mouth” of the character on the attachment, adding an aesthetically pleasing feature that makes the room more aesthetically pleasing and makes the outlet more noticeable, among other functions.

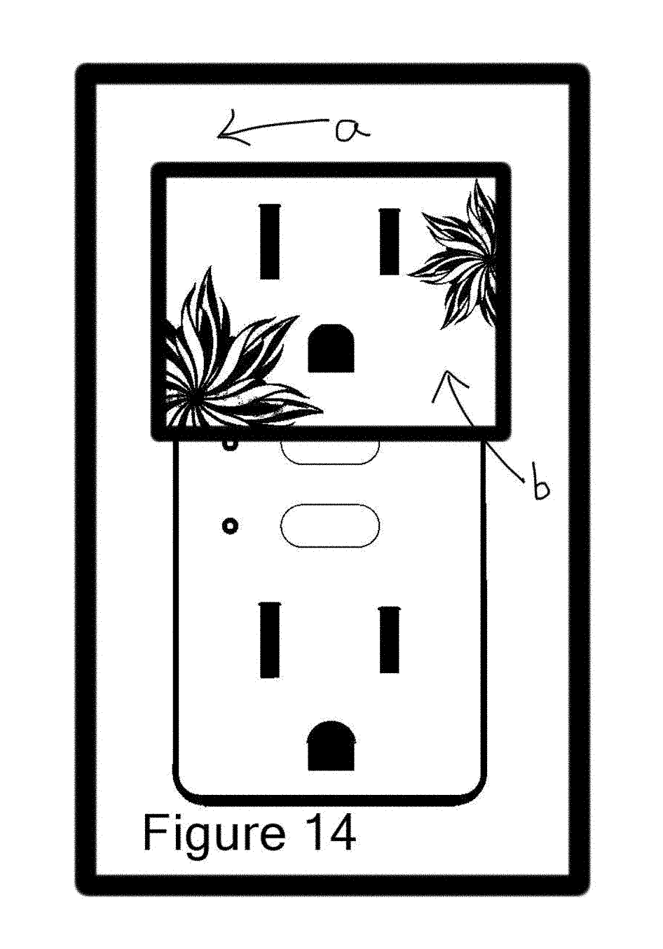

FIG. 14 depicts an attachment having a floral pattern. Element (a) corresponds to the existing faceplate of the outlet. Element (b) corresponds to the attachment which can be a sticker or other form of attachment, as described in the above specification. In this embodiment, the material that would glow (in the embodiment that glows) is the white area around the outlet holes and within the rectangle that forms the border of the floral pattern. As above, holes are made in the attachment, corresponding in size, shape, and spacing to the holes in an outlet, made in order to allow someone to plug something into the attachment.

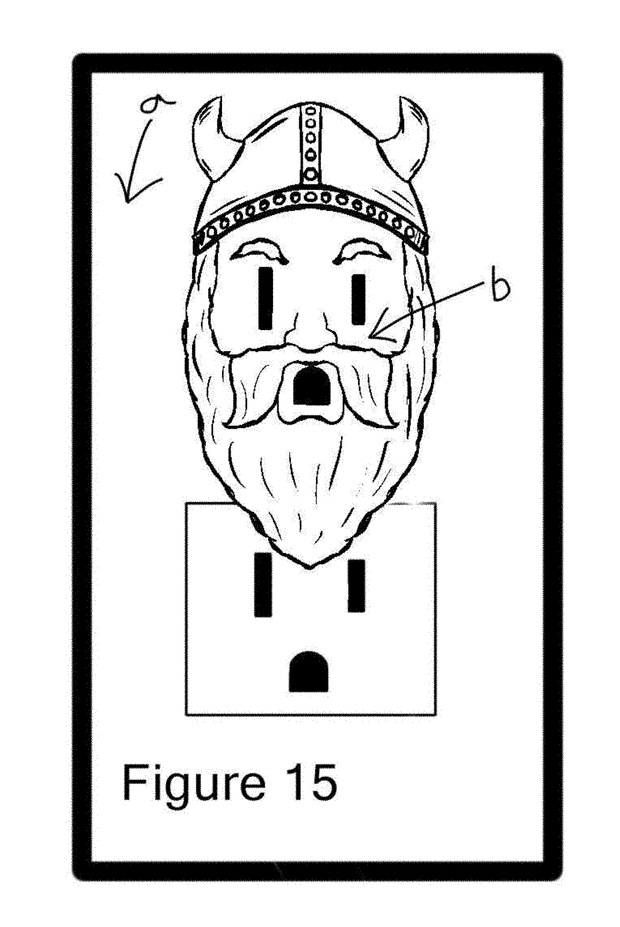

FIG. 15 is another embodiment of an outlet attachment similar to that of FIGS. 11-14, where in this instance the design is that of a Viking. The holes of the outlet make up the “eyes” and “mouth” of the character on the attachment. Element (a) corresponds to the existing faceplate of the outlet. Element (b) corresponds to the invention itself, which is in the embodiment of an attachment to outlets. The attachment (b) can be a sticker or other form of attachment, as described in the above specification. In this embodiment, the material that would glow (in the embodiment that glows) is either the area of the “face” above the beard and below the helmet, as well as the area surrounding the “mouth”, or alternatively, the entire attachment, with the exception of the black lines that form the design. As described above, holes are made in the attachment, corresponding in size, shape, and spacing to the holes in an outlet, made in order to allow someone to plug something into the attachment in an unobstructed fashion.

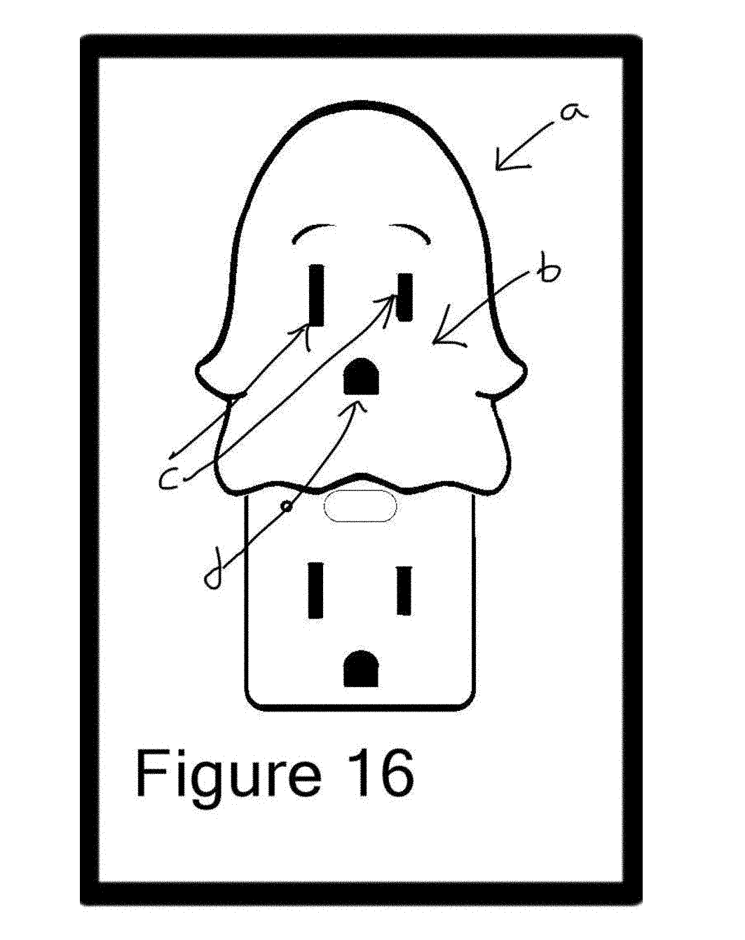

FIG. 16 is another embodiment of the outlet attachment of FIGS. 11-15, which, in this embodiment, takes the form of a “ghost”-like character. Element (a) is the existing faceplate on the outlet. Element (b) is the attachment, which is in the embodiment of an attachment to outlets. The attachment (b) can be a sticker or other form of attachment, as described in the above specification. In this embodiment, the material that would glow would be the entire attachment, except for the line art of the image. Element (c) corresponds to the two rectangular holes that are made in the attachment to allow access to the holes in an outlet. Element (d) corresponds to the third hole made in the attachment, that is of the proper shape and size to allow access to the third hole.

In the preferred embodiment, the attachment (b) glows in the dark. In alternative embodiments, the attachment (b) may not be glow in the dark, but may be of a color or pattern that makes it attractive and aesthetically pleasing. In other alternative embodiments, the attachment (b) is lit by electric means. The holes (c) and (d) in the attachment (b) are of the proper size, shape and spacing to allow for easy plugging into the holes. They correspond to and align with the holes on the outlet. Their presence ensures that the outlet is not obstructed, and that it retains full functionality.

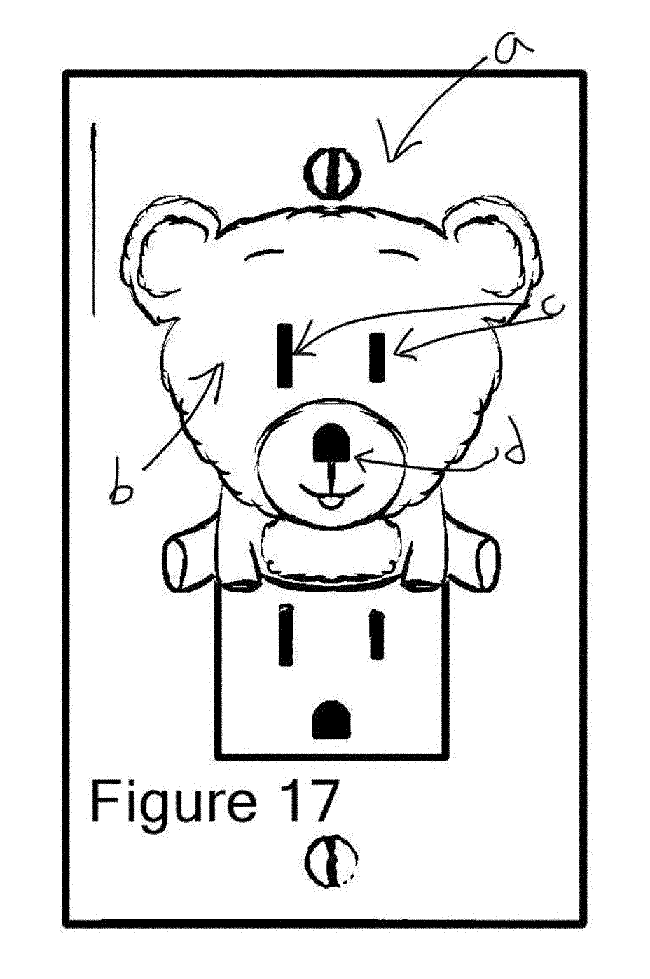

FIG. 17 is another embodiment of the outlet attachment of FIGS. 11-16, which, in this embodiment, takes the form of a “bear”-like character. Element (a) is the existing faceplate on the outlet. Element (b) is the attachment itself, which is in the embodiment of an attachment for outlets. It can be a sticker or other form of attachment, as previously described. In this embodiment, the material that would glow would be the entire attachment (b), except for the line art of the image. In alternative embodiments, only the face of the character would glow.

Element (c) corresponds to the two rectangular holes that are made in the attachment to allow access to the holes in an outlet. Element (d) corresponds to the third hole made in the attachment, that is of the proper shape and size to allow access to the third hole. In this embodiment, the third hole is used as a “nose”, adding a unique design element that is whimsical and fun.

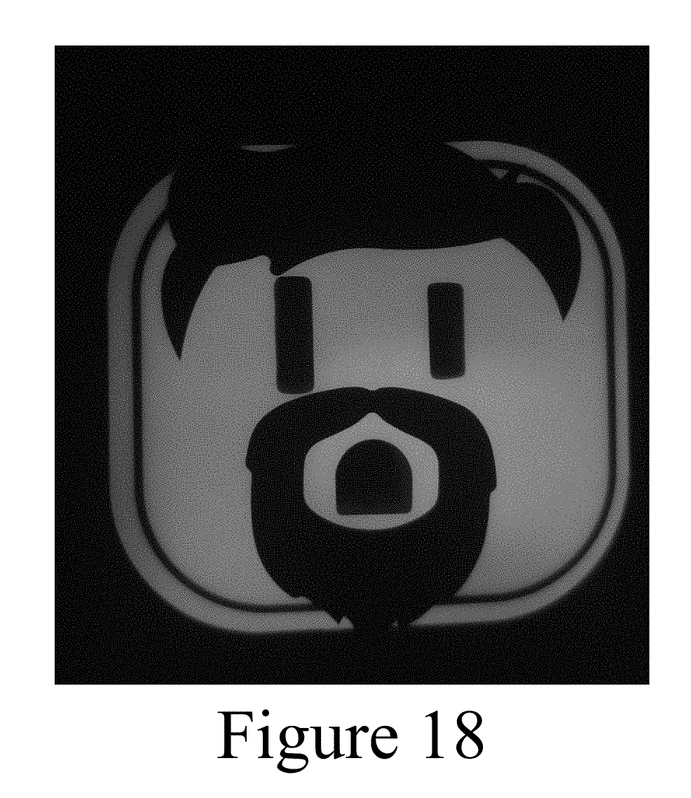

FIG. 18 depicts the attachment (b) of FIG. 10 with additional “accessories.” These accessories are compatible with any of the attachments depicted in FIGS. 1-17. Essentially, the accessories are additional attachments which a user can use to enhance the primary attachment that has been placed onto the light switch or outlet. For example, as shown in FIG. 18, a “hair” accessory and a “beard” accessory have been placed over the holes in the attachment (b) so that it appears as if the outlet forms a face, with the two vertical slits of the outlet as eyes and the ground hole as a mouth. The accessories may take any shape or form. For example, the accessories may represent interchangeable hair styles or face shapes. Alternatively, accessories may be design for specific attachments. As an example, specific accessories may be used to accentuate the bear attachment depicted in FIG. 17 or the ghost attachment depicted in FIG. 16. The accessories can be hats or any other shapes suitable for the characters.

The accessories may be formed from a similar material used to create the underlying attachments (b). Preferably, the accessories are removable so that they can be mixed and matched with other accessories or attachments. Thus, in a preferred embodiment, the accessories adhere to the attachment (b) using a removable connection, such as a static, magnetic, or using temporary adhesives. The accessories may be glow in the dark or have various designs and shapes as has been described.

In further embodiments, the attachments may additional comprise space for a customizable logo. The attachment would have space for a company logo on it, either on the top or bottom, enabling it to be customized for a company's individual needs. In an alternate embodiment, the customizable logo can be provided as an accessory to be placed on top of an attachment.

1. An attachment for a fixture for a light switch, the attachment comprising:
a rear surface adapted to be attached to the fixture; and
a front surface having at least one portion comprising a glow in the dark surface.

2. The attachment of claim 1, further comprising:
a hole in a center of the attachment, wherein the hole is sized to completely surround the light switch.

3. The attachment of claim 1, wherein the attachment is sized to be placed directly on the light switch without overlapping an exterior perimeter of the light switch.

4. An attachment for an outlet faceplate, the attachment comprising:
a rear surface adapted to be attached to the faceplate, and
a front surface having at least one portion comprising a design or a glow in the dark surface; and
a plurality of holes in the attachment surface, wherein the holes are sized and spaced to provide access to the holes of an outlet provided under the attachment when the attachment is placed on the outlet faceplate.

5. The attachment according to claim 4, wherein the front surface comprises a design for a face, with two holes of the plurality of holes forming eyes of the face.

6. The attachment according to claim 5, wherein a third hole of the plurality of holes forms a mouth or a nose of the face.

7. The attachment according to claim 4, wherein the glow in the dark surface is located only above a perimeter of the outlet.

8. The attachment according to claim 4, further comprising:
a plurality of accessories configured to be adhered to the front surface of the attachment using a releasable connection.

9. The attachment according to claim 4, wherein the rear surface of the attachment comprises an adhesive.

10. The attachment according to claim 4, wherein the attachment has a shape that does not overlap with a second outlet on the outlet faceplate.

11. The attachment according to claim 4, wherein the attachment is removably attached to the faceplate.
